(19) United States
(12) Patent Application Publication
(10) Pub. No.: US 2026/0178552 A1
(43) Pub. Date: Jun. 25, 2026

(54) MAPPING ATTRIBUTES FROM SERVICE BASED INTERFACES TO CHARGING DATA RECORD INTERFACES

(71) Applicant: Telefonaktiebolaget LM Ericsson (publ), Stockholm (SE)

(72) Inventor: Robert TÖRNKVIST, Karlskrona (SE)

(73) Assignee: Telefonaktiebolaget LM Ericsson (publ), Stockholm (SE)

(21) Appl. No.: 19/124,332

(22) PCT Filed: Dec. 6, 2022
(86) PCT No.: PCT/SE2022/051147

§ 371 Date: Apr. 25, 2025

Related U.S. Application Data
(60) Provisional application No. 63/421,626, filed on Nov. 2, 2022.

(51) Int. Cl. G06F 16/22; G06F 16/23

(52) U.S. Cl. CPC G06F 16/22; G06F 16/2365

(57) ABSTRACT

A method is provided for a first function of a network node a communications system for encoding a charging data record (CDR). Charging information is received containing attributes and values that are coded according to a service based interface syntax. A structure of a first part of the CDR is identified that is undefined by a first CDR syntax for storage of a combination of an attribute and value of the charging information in the CDR. The structure of the first part of the CDR is hashed to generate a hash value. The hash value and the combination of the attribute and value are stored in a second part of the CDR which is defined by the first CDR syntax for use in storage of undefined attributes and values.

### TECHNICAL FIELD

The present disclosure relates to mobile communications networks and recording network resource usage information related to communications through communication networks provided by mobile network operators.

### BACKGROUND

The 3rd Generation Partnership Project (3GPP) through its standards organizations has specified a service based architecture in 3GPP TS 32.290 v16.3.0 where a network function (NF) may request charging from a charging function (CHF), and has specified in 3GPP TS 32.298 v16.9.0 the information elements to be added by a CHF to a Charging Data Record (CDR) for use by billing systems.

For charging there are two types of interfaces, service based interface (SBI) as described in reference [1] and Diameter based interface as described in reference [3]. Charging from either of these interfaces needs to be converted to a CDR according to reference [2] before being sent to other systems for billing or storage.

The network functions send charging information to the CHF which may rate, and update balances based on the information as well as grant units in the response. The charging information received is coded into CDRs according to the ASN.1 format for further processing by billing systems. The CDRs may also be used by other business systems, and may be stored for, e.g., legal purposes, and used for statics and network maintenance.

If the charging information contains mandatory fields that cannot be stored in the CDR, the CHF may respond with an error. Alternatively, if the charging information contains fields or values that are optional and which cannot be stored in the CDR, the CHF may just ignore these fields or values when generating the CDR and possibly without generating a notification to the sending function.

### SUMMARY

Some embodiments of the present disclosure are directed to a method by a first function of a network node of a communications system for encoding a CDR. The method includes receiving charging information containing attributes and values that are coded according to a service based interface (SBI) syntax, and identifying a structure of a first part of the CDR that is undefined by a first CDR syntax for storage of a combination of an attribute and value of the charging information in the CDR. The method further includes hashing the structure of the first part of the CDR to generate a hash value, and storing the hash value and the combination of the attribute and value in a second part of the CDR which is defined by the first CDR syntax for use in storage of undefined attributes and values.

Some other embodiments of the present disclosure are directed to a method by a second function of a network node of a communications system. The method includes receiving a CDR that contains a hash value and a combination of an attribute and value stored at a second part of the CDR which is defined by a first CDR syntax for use in storage of undefined attributes and values. The method further includes matching the hash value to a reference hash value identifying a first part of the CDR that is defined by a second CDR syntax for use in storage of the combination of the attribute and value in the CDR, and storing the combination of the attribute and value in the first part of the CDR.

Some other embodiments are directed to a related first function by a network node of a communications system for encoding a CDR. The network node includes at least one processor and at least one memory coupled to the at least one processor and storing computer readable program code that when executed by the at least one processor causes the at least one processor to perform operations. The operations are configured to receive charging information containing attributes and values that are coded according to a SBI syntax, identify a combination of an attribute and value of the charging information that is undefined by a first CDR syntax for storage in the CDR, and identify a structure of a first part of the CDR that is defined by a second CDR syntax for storage of the combination of the attribute and value. The operations further hash the structure of the first part of the CDR that is defined by a second CDR syntax to generate a hash value, and store the hash value and the combination of the attribute and value in a second part of the CDR which is defined by the first CDR syntax for use in storage of undefined attributes and values.

Some other embodiments are directed to a related second function by a network node of a communications system. The network node includes at least one processor and at least one memory coupled to the at least one processor and storing computer readable program code that when executed by the at least one processor causes the at least one processor to perform operations. The operations are configured to receive a CDR that contains a hash value and a combination of an attribute and value stored at a second part of the CDR which is defined by a first CDR syntax for use in storage of undefined attributes and values. The operations further match the hash value to a reference hash value identifying a first part of the CDR that is defined by a second CDR syntax for use in storage of the combination of the attribute and value, and store the combination of the attribute and value in the first part of the CDR.

Some embodiments of the present disclosure are directed to providing and supporting a second CDR syntax, e.g., new CDR syntax, when encoded by the first function that is not aware of the second CDR syntax but is aware of a first CDR syntax, e.g., older CDR syntax. The hash value that is stored with the combination of the attribute and value of the charging information by the first function, can be used by the second function to determine where in the hashed structure of the first part of the CDR the attribute and value is to be stored by the second function pursuant to the second CDR syntax which is known to the second function.

### BRIEF DESCRIPTION OF THE DRAWINGS

Aspects of the present disclosure are illustrated by way of example and are not limited by the accompanying drawings. In the drawings:

FIG. 1 illustrates a block diagram of a communications system that includes a user plane function, a session management function, a charging function, a charging gateway function and/or mediation function, and a billing system which are configured to operate in accordance with some embodiments of the present disclosure;

FIG. 2 illustrates a data flow diagram showing operations performed by the charging trigger function, the charging function, the mediation function, and the billing system of FIG. 1 in accordance with some embodiments of the present disclosure; and

FIG. 3 illustrates a flowchart of operations that can be performed by a first function, e.g., charging function of FIG. 1, of a network node in accordance with some embodiments of the present disclosure;

FIG. 4 illustrates a flowchart of operations that can be performed by a second function, e.g., mediation function and/or billing system of FIG. 1, of the network node or another network node in accordance with some embodiments of the present disclosure; and

FIG. 5 illustrates a block diagram of components of a network node which are configured to operate in accordance with some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of various present inventive concepts to those skilled in the art. It should also be noted that these embodiments are not mutually exclusive. Components from one embodiment may be tacitly assumed to be present/used in another embodiment.

The interfaces for charging, e.g., service based interface (SBI), are often more advanced than the CDR based interfaces. The charging interfaces are driven from the network side while the CDR interfaces are driven from the business side. Because of the differences, the two interfaces can have synchronization issues. For example, if information from the CDR interface is passed to the SBI, some fields may not be filled. In contrast, if information from the SBI is passed to the CDR interface some fields may be discarded since they cannot be converted, and which can result in loss of information.

If the CDRs are later updated to accommodate the charging information that couldn't be stored there is no way of recovering this. If function or system node other than the CHF, such as a mediation function, would have an updated CDR version the CHF would have discarded the information and there is no way for the downstream function(s) or system node(s) to recover the information.

Some embodiments of the present disclosure are directed to providing and supporting a new CDR syntax to store and associate parameters that cannot be converted to a CDR according to another (e.g., earlier) syntax for that CDR, and which creates a hash that is used to identify where the parameters should have been stored in that CDR if the new CDR syntax was used. Potential advantages can include that a function of a network node that supports the new CDR syntax can receive the CDR and create a new CDR according to the new CDR syntax with the parameters stored as the CDR should have looked if the initial function which generated the CDR had supported the new CDR syntax. The new CDR syntax may correspond to a syntax that is based on requirements of a customer or an equipment specific CDR.

Two operational approaches that may be used to indicate the parameters in a CDR can include: 1) adding undefined values in all places of the CDR structure; and 2) adding a sequence of reference numbers to all CDR structures so that they can referenced. However, both of these operational approaches can add extra data that may need to be evaluated even if it is rarely used and make the CDR structures unnecessary complex.

Some embodiments are therefore directed to enabling the charging mechanism to identify a structure of a first part of a CDR that is undefined by an first (e.g., older) CDR syntax for storage of a combination of an attribute and value of the charging information in the CDR. The charging mechanism hashes the structure of the first part of the CDR to generate a hash value. The charging mechanism then stores the hash value and the combination of the attribute and value in a second part of the CDR which is defined by the first CDR syntax for use in storage of undefined attributes and values. Another function receiving the CDR can then use the hash value to identify a first part of the CDR that is defined by a second (e.g., newer) CDR syntax for use in storage of the combination of the attribute and value, and can store the combination of the attribute and value in the first part of the CDR. The second (e.g., newer) CDR syntax may have an expanded definition of where additional types of combinations of attributes and values are to be stored in a CDR.

In this manner, combinations of attributes and values which cannot be converted to a CDR according to a first (e.g., older) CDR syntax, can still be stored in the CDR and then used by another function receiving the CDR and which understands the second (e.g., newer) CDR syntax to update the CDR by storing the combination of attribute and value in a part of the CDR according to the second (e.g., newer) CDR syntax.

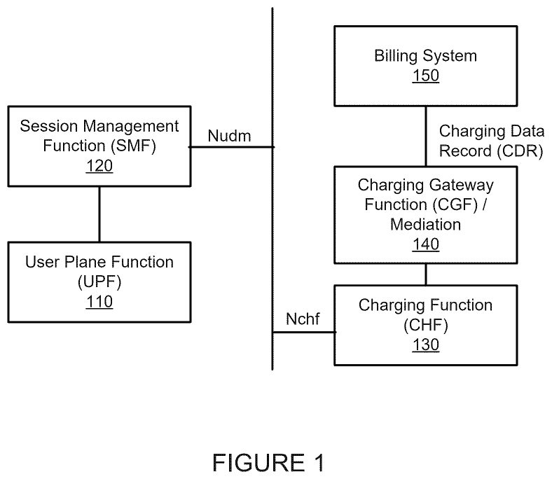

These and other related embodiments are now described with reference to FIGS. 1 to 5.

FIG. 1 illustrates a block diagram of a communications system that includes a user plane function (UPF) 110, a session management function (SMF) 120, a charging function (CHF) 130, a charging gateway function (CGF) and/or mediation function 140, and a billing system 150 which are configured to operate in accordance with some embodiments of the present disclosure.

Referring to FIG. 1, the SMF 120 operates to manage the 5G data connections and report the usage (charging information) to the CHF 130 using the Nchf interface. The SMF 120 may operation to track PDU sessions and QoS Flows in the 5GC for user equipments (UEs) and ensure their states and status are in sync between network functions in the control and user planes, such as the UPF 110. The SMF 120 is a nonlimiting example of a network function providing charging information. Other such network functions that can provide charging information include Network Exposure Function (NEF), Short Message Service Function (SMSF). The network function providing charging information may operate as a Charging Trigger Function (CTF).

The network function(s), e.g., SMF 120, send charging information to the CHF 130 which may rate, and update balances based on the information as well as grant units in the response. The CGF 140 handles the interaction with the billing system 150 and operates as a gateway from the CHF 130 point of view. The CGF 140 operation can correspond to mediation and, if so, it may also perform modifications and additions to the CDRs. The CHF 140 can operate to convert the charging information from the SMF 120 into CDRs. The billing system 150 may use the CDRs to create bills and store CDRs for, e.g., legal purposes, and used for statics and network maintenance. The CDRs may therefore be processed by the mediation 140 function before forwarding to the billing system 150 to, e.g., facilitate storage and use of the CDRs by various entities.

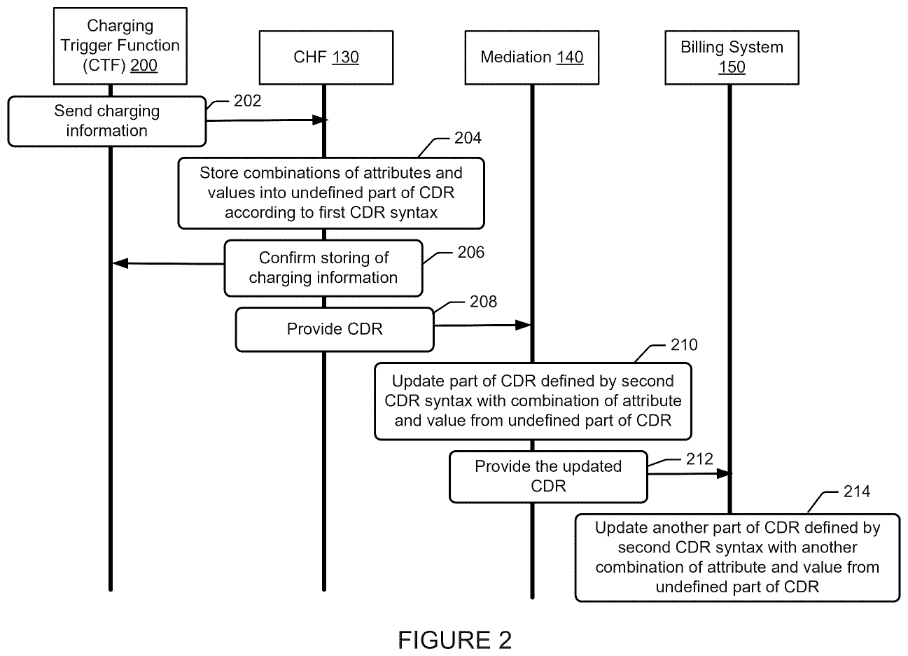

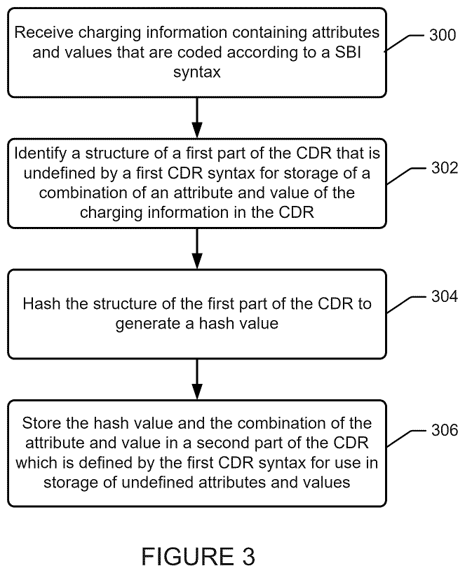

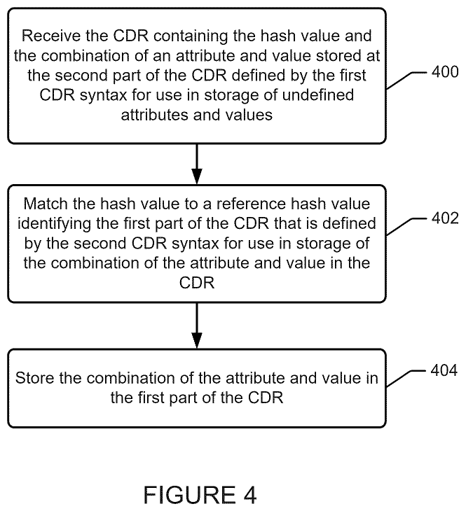

FIG. 2 illustrates a data flow diagram showing operations performed by the CTF 200, the CHF 130, the mediation 140 function, and the billing system 150 of FIG. 1 in accordance with some embodiments of the present disclosure. FIG. 3 illustrates a flowchart of operations that can be performed by a first function of a network node, e.g., the CHF 130 of the communications system of FIG. 1, in accordance with some embodiments of the present disclosure. FIG. 4 illustrates a flowchart of operations that can be performed by a second function, e.g., the mediation 140 function and/or the billing system 150 of FIG. 1, of the network node or another network node in accordance with some embodiments of the present disclosure.

The more generalized operations of FIGS. 3 and 4 are discussed in accordance with some embodiments before the more particular operations of FIG. 2 are described in accordance with some further embodiments. A mapping of some of the operations in FIG. 2 are also briefly mentioned where applicable as examples of the operations illustrated in FIGS. 3 and 4.

Referring to FIGS. 2 and 3, the illustrated operations can be performed by a first function of a network node of a communications system. The first function may correspond to the CHF 130. The operations include to receive 300 (204 in FIG. 2) charging information containing attributes and values that are coded according to a service based interface (SBI) syntax. The operations identify 302 (204 in FIG. 2) a structure of a first part of the CDR that is undefined by a first CDR syntax for storage of a combination of an attribute and value of the charging information in the CDR. Because the first CDR syntax does not define the structure of the first part of the CDR for storage of the combination of the attribute and value, the operations hash 304 (204 in FIG. 2) the structure of the first part of the CDR to generate a hash value, and store 306 (204 in FIG. 2) the hash value and the combination of the attribute and value in a second part of the CDR which is defined by the first CDR syntax for use in storage of undefined attributes and values.

As will be explained in further detail below with regard to FIGS. 2 and 4, a second function receives the CDR and uses the hash value to identify the first part of the CDR that is defined by a second CDR syntax for use in storage of the combination of the attribute and value in the CDR, and then stores the combination of the attribute and value in the first part of the CDR. Accordingly, although the first function does not know the second CDR syntax, e.g., because it is a new CDR syntax, the first function can generate and store the hash in the CDR according to the first CDR syntax and which can be used by the second function to determine where to store the combination of attribute and value into the CDR according to the CDR structure defined by the second CDR syntax. As will be explained below, the second function may use the hash value to lookup, e.g., in a table, where in the CDR structure the attribute and value are to be stored, or may hash CDR structure defined by the second CDR syntax to find a match to the hash value and thereby identify where the attributed and value are to be stored.

In a further embodiment, the first function provides (208 in FIG. 2) the CDR, containing the hash value and the combination of the attribute and value, to a second function which may be provided by the same network node as the first function or may be provided by another network node. The second function may correspond to the mediation 140 function and/or the billing system 150.

In some further embodiments, the structure of the first part of the CDR is a nested data structure containing hierarchical levels of nested attributes, and the operation to hash 306 (204 in FIG. 2) the structure of the first part of the CDR to generate the hash value, includes to hash at least one of the hierarchical levels of the nested attributes. The hashing of the at least one of the hierarchical levels of the nested attributes, may include selecting a highest one of the hierarchical levels of the nested attributes that is undefined by the first CDR syntax for storage of the combination of the attribute and value in the CDR, and then hashing the highest one of the hierarchical levels of the nested attributes and any lower ones of the hierarchical levels of the nested attributes to generate the hash value.

In some further embodiments, the first function of the network node includes the CHF 130, and the first function receives the charging information from a charging trigger function 200 in FIG. 2. The first function may receive the charging information from a session management function (SMF), a short message service function (SMSF), or a network exposure function (NEF).

Referring now to FIGS. 2 and 4, the illustrated operations can be performed by a second function of the network node of FIG. 3 or another network node of the communications system.

The second function may correspond to the mediation 140 function or the billing system 150 in accordance with some embodiments.

The operations by the second function include to receive 400 (210 in FIG. 2) the CDR that contains the hash value and the combination of an attribute and value stored at the second part of the CDR which is defined by the first CDR syntax for use in storage of undefined attributes and values. The operations match 402 (210 in FIG. 2) the hash value to a reference hash value identifying the first part of the CDR that is defined by a second CDR syntax for use in storage of the combination of the attribute and value in the CDR. The operations store 406 (210 in FIG. 2) the combination of the attribute and value in the first part of the CDR.

In some further embodiments, the operation by the second function to match 402 (210 in FIG. 2) the hash value to the reference hash value, includes to hash the structure of the first part of the CDR, that is defined by the second CDR syntax, to generate the reference hash value. The structure of the first part of the CDR may be a nested data structure containing hierarchical levels of nested attributes, and the hashing of the structure of the first part of the CDR to generate the reference hash value can include to hash at least one of the hierarchical levels of the nested attributes. The operations may select a highest one of the hierarchical levels of the nested attributes that is undefined by the first CDR syntax for storage of the combination of the attribute and value in the CDR and is defined by the second CDR syntax for storage of the combination of the attribute and value in the first part of the CDR, and hash the highest one of the hierarchical levels of the nested attributes and any lower ones of the hierarchical levels of the nested attributes to generate the hash value.

In some further embodiments, the operation by the second function to match 402 (210 in FIG. 2) the hash value to the reference hash value can include to access a table that associates reference hash values to parts of the CDR which are defined by the second CDR syntax for use in storage of combinations of attributes and values, and to use the hash value as a pointer in the table to lookup the first part of the CDR.

Further example operations are now explained in the context of FIG. 2. Referring to FIG. 2, The CTF 200 sends 202 the charging information to the CHF 130. As explained above, the CHF 130 may, for example, be a SMF, SMSF, NEF, etc. The CTF 200 action to send the charging information can be triggered by a defined event becoming satisfied.

The CHF 130 evaluates the charging information and may perform rating and/or account balance management. The CHF 130 stores the charging information into a CDR in accordance with a first CDR syntax for encoding the charging information into the CDR. However, when the CHF 130 encounters an undefined attribute or value, referred to as an undefined combination of attribute and value, the CHF 130 identifies 204 a structure of a first part of the CDR that is undefined by the first CDR syntax for storage of the combination of the attribute and value in the CDR. The CHF 130 hashes 204 the structure of the first part of the CDR to generate a hash value and stores 204 the hash value and the combination of the attribute and value in a second part of the CDR which is defined by the first CDR syntax for use in storage of undefined attributes and values. A detailed example of a structure which is hashed is discussed further below.

As explained above, the first CDR syntax may correspond to an older CDR syntax while the second CDR syntax may correspond to a newer CDR syntax that has an expanded definition of where additional types of combinations of attributes and values are to be stored in a CDR. In an example embodiment, the CHF 130 stores 204 the hash value and the combination of attribute and value in the UndefinedInformation part of the CDR. The second part of the CDR may be any part where undefined attributes are to be stored which can be complex data types, (e.g., a nested data structure containing hierarchical levels of nested attributes) and in particular attributes that have multiple occurrences.

The CHF 130 may confirm 206 to the CTF 200 the storing of the charging information and may indicate to the CTF 200 a grating of units.

The CHF 130 provides 208 the CDR to the mediation 140, which may include the CHF 130 sending the CDR to the mediation 140 or the mediation 140 fetching the CDR from the CHF 130. The CDR may be provided immediately after the CDR is created or updated by the storing 204 or may be provided later responsive to a defined condition becoming satisfied.

The mediation 140 function checks 210 the UndefinedInformation and, when the mediation 140 supports a second CDR syntax defining one or more of the combinations of attributes and values in the UndefinedInformation part of the CDR, the mediation 140 will responsively create hash values (e.g., reference hash values) of structures of parts of the CDR which are defined by the CDR syntax for storage of the corresponding combinations, such as typically complex data types (e.g., reference attributes defined by the second CDR syntax), and in particular attributes that have multiple occurrences. When the mediation 140 finds a matching hash value (e.g., between the hash value in the UndefinedInformation and the reference hash value), the mediation 140 stores 210 the attribute and value from the UndefinedInformation part of the CDR into the CDR at a first part of the CDR corresponding to reference hash value.

The mediation 140 provides 212 the updated CDR to the billing system 150, which may include the mediation 140 sending the updated CDR to the billing system 150 or the billing system 150 fetching the updated CDR from the mediation 140. The updated CDR may be provided immediately after it is created or updated 210 or may be provided later responsive to a defined condition becoming satisfied.

In a similar manner, the billing system 150 or other node of the system checks 214 the UndefinedInformation part of the updated CDR and, when the billing system 150 supports one or more of the attributes stored in the UndefinedInformation part of the updated CDR according to the second CDR syntax, the billing system 150 will responsively create hash values (e.g., reference hash values) of the attributes. When the billing system 150 finds a matching hash value (e.g., between the hash value in the UndefinedInformation and the reference hash value), the billing system 150 further updates 214 the CDR with the attribute and value.

An example CDR is shown below which has attributes and values of charging information that are stored in the UndefinedInformation part (described above as the second part) of the CDR (illustrated with underlining) pursuant to a first CDR syntax for use in storage of undefined attributes and values, and in accordance with some embodiments of the present disclosure:

ChargingRecord ::= SET
{

| | |
|---|---|
| recordType | [0] RecordType, |
| recordingNetworkFunctionID | [1] NetworkFunctionName, |
| subscriberIdentifier | [2] SubscriptionID OPTIONAL, |
| nFunctionConsumerInformation | [3] NetworkFunctionInformation, |
| triggers | [4] SEQUENCE OF Trigger OPTIONAL, |
| listOfMultipleUnitUsage | [5] SEQUENCE OF MultipleUnitUsage |

OPTIONAL,

| | |
|---|---|
| recordOpeningTime | [6] TimeStamp, |
| duration | [7] CallDuration, |
| recordSequenceNumber | [8] INTEGER OPTIONAL, |
| causeForRecClosing | [9] CauseForRecClosing, |
| diagnostics | [10] Diagnostics OPTIONAL, |
| localRecordSequenceNumber | [11] LocalSequenceNumber OPTIONAL, |
| recordExtensions | [12] ManagementExtensions OPTIONAL, |
| pDUSessionChargingInformation | [13] PDUSessionChargingInformation |

OPTIONAL,

| | |
|---|---|
| roamingQBCInformation | [14] RoamingQBCInformation OPTIONAL, |
| sMSChargingInformation | [15] SMSChargingInformation OPTIONAL, |
| chargingSessionIdentifier | [16] ChargingSessionIdentifier OPTIONAL, |
| serviceSpecificationInformation | [17] OCTET STRING OPTIONAL, |
| exposureFunctionAPIInformation | [18] ExposureFunctionAPIInformation |

OPTIONAL,

| | |
|---|---|
| registrationChargingInformation | [19] RegistrationChargingInformation |

OPTIONAL,

| | |
|---|---|
| n2ConnectionChargingInformation | [20] N2ConnectionChargingInformation |

OPTIONAL,

| | |
|---|---|
| locationReportingChargingInformation | [21] LocationReportingChargingInformation |

OPTIONAL,

| | |
|---|---|
| incompleteCDRIndication | [22] IncompleteCDRIndication OPTIONAL, |
| tenantIdentifier | [23] TenantIdentifier OPTIONAL, |
| mnSConsumerIdentifier | [24] MnSConsumerIdentifier OPTIONAL, |
| nSMChargingInformation | [25] NSMChargingInformation OPTIONAL, |
| nSPAChargingInformation | [26] NSPAChargingInformation OPTIONAL, |
| chargingID | [27] ChargingID OPTIONAL, |
| iMSChargingInformation | [28] IMSChargingInformation OPTIONAL, |
| mMTelChargingInformation | [29] MMTelChargingInformation |

OPTIONAL,

| | |
|---|---|
| edgeInfrastructureUsageChargingInformation | [30] |

EdgeInfrastructureUsageChargingInformation OPTIONAL,

| | |
|---|---|
| eASDeploymentChargingInformation | [31] |

EASDeploymentChargingInformation OPTIONAL,

| | |
|---|---|
| directEdgeEnablingServiceChargingInformation | [32] |

ExposureFunctionAPIInformation OPTIONAL,

| | |
|---|---|
| exposedEdgeEnablingServiceChargingInformation | [33] |

ExposureFunctionAPIInformation OPTIONAL,

| | |
|---|---|
| proseChargingInformation | [34] ProseChargingInformation OPTIONAL, |
| eASID | [35] UTF8String OPTIONAL, |
| eDNID | [36] UTF8String OPTIONAL, |
| eASProviderIdentifier | [37] UTF8String OPTIONAL, |

```
  undefiedInformation [40] UndefinedInformation, OPTIONAL
}
UndefinedInformation ::= SET
{
  aPIName [0] UTF8String,
  aPIVersion [1] UTF8String,
  multiple UndefinedAttributes [2] SEQUENCE OF undefinedAttribute
}
UndefinedAttribute ::= SEQUENCE
{
  resource [0] UTF8String,
  value [1] UTF8String,
  sequenceNumber [2] INTEGER OPTIONAL
  hashValue [3] UTF8String OPTIONAL
```

The following attributes can be added to 3GPP TS 32.298 V17.4.0, reference [2], clause 5.2.5.2, in accordance with some embodiments:
UndefinedInformation: the information about the attributes that cannot be stored in the CDR
   APIName: the name of the API and service used in, e.g., Nchf_ConvergedCharging or Nchf_OfflineOnlyCharging
   APIVersion: the version of the API, e.g., 3.1.1
   UndefinedAttribute: actual attribute name and value, and may have multiple occurencies
      Resource: the path and name of the resource attribute, e.g., “/multiple UnitUsage/usedUnitContainer/pDUContainerInformation/rA TType”
      Value: the value of the attribute, since all attributes (for openAPI) will be possible to represent as a string, even the ones that are objects, e.g., “NR_GEO”.
      SequenceNumber: if the attribute is within an attribute that have multiple occurrences and this has a sequence number that may identify it, this would contain the value of the sequence e.g., LocalSequenceNumber in the MultipleQFIContainer and UsedUnitContainer.
      hashValue: alternative to the SequenceNumber especially if there is no means to identify the specific occurrences, the system would create a hash based uniquely identifying a specific occurrence of an attribute that have multiple occurrences, e.g., RANSecondaryRATUsageReport.

The hashing algorithm can be performed in any manner of, e.g., creating a hash value(s) from a string. The hashing operation may be performed by providing the described parameter and value as input to any type of hashing algorithm, such as the MD-2 (message digest 2), MD-5, or SHA-1 (standard hashing algorithm 1) hash algorithms. These are non-limiting examples because other hashing algorithms or other coding functions may be used. Using the MD-2 or MD-5 hash algorithms, the hash result can be a 16-bite (128-bit) value regardless of the length of the input value. The CHF 130, mediation 140, billing system 150 should or must use the same hashing algorithm and approach for hashing so that the resulting hash values can identically match. For example, the hashing can start from an attribute defined by a complex data type and one instance of the attribute.

Further example operations are now explained by way of a particular example of the listOfMultipleUnitUsage defined in to 3GPP TS 32.298 V17.4.0, reference [2], clause 5.2.5.2 which can have multiple occurrences and is a complex data type defined by MultipleUnitUsage. In this case, one entry in the list listOfMultipleUnitUsage would be used to calculate the hash value if it would contain an undefined attribute or value. In this case the value “NR-GEO” of the rATTYPE is unknown by the CHF 130 (undefined by a first CDR syntax for storage in a CDR). The CHF 130 responsively operates to create a hash value of the pDUContainerInformation where the rATType is not included. The mediation 140 determines that it understands the new rATType value (i.e., according to use of the second CDR syntax) and creates hash values for both the pDUContainerInformation (where the hash values serve as reference hash values) and finds that the second hash value matches the hash value in the undefined attribute. The mediation 140 then adds (stores) the value rATType: nR-GEO to the second pDUContainerInformation before sending it to other functions or nodes, e.g., billing system 150.

```
listOfMultipleUnitUsage
start, length
  ratingGroup: “10”
  usedUnitContainers
    serviceIdentifier: “101”
    time: “123”
    triggers
      sMFTrigger: tAIChange
    triggerTimeStamp: “120023”
    dataTotalVolume: “12000”
    pDUContainerInformation
      timeOfFirstUsage: “120021”
      timeOfLastUsage: “120023”
      qoSInformation
        fiveQI: “10”
      rATType: 201 (nR)
# The CDR (ASN.1) corresponding value (201) to the “NR” received from the SMF over
SBI (OpenAPI) is known by the CHF.
start, length
  ratingGroup: “10”
  usedUnitContainers
    serviceIdentifier: “101”
    time: “234”
    triggers
      sMFTrigger: rATTypeChange
    triggerTimeStamp: “120024”
    dataTotalVolume: “100”
    pDUContainerInformation
      timeOfFirstUsage: “120023”
      timeOfLastUsage: “120024”
      qoSInformation
        fiveQI: “10”
undefinedInformation
  aPIName: “Nchf_ConvergedCharging”
  aPIVersion: “1.1.0”
  multipleUndefinedAttributes
  start, length
    resource:
“/multipleUnitUsage/usedUnitContainer/pDUContainerInformation/rATType”
    value: “NR-GEO”
# The value “NR-GEO” is the value received from the SMF over SBI (OpenAPI) and
the corresponding value in the CDR (ASN.1) is not know by either SMF or CHF.
    hash Value: “a123ef8762effab09764”
```

The hash Value: “a123ef8762effab09764” is generated by hashing the structure of the first part of the CDR that is undefined by a first CDR syntax for storage of a combination of an attribute and value of the charging information in the CDR, which in this this example corresponds to hashing the following structure:

```
pDUContainerInformation
  timeOfFirstUsage: “120023”
  timeOfLastUsage: “120024”
  qoSInformation
    fiveQI: “10”
```

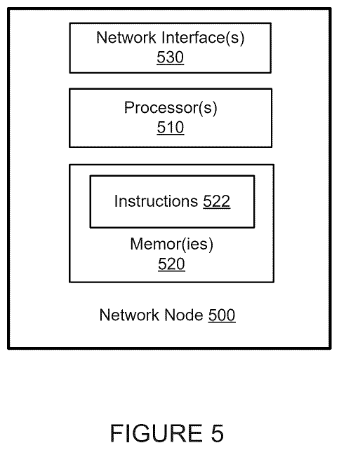

FIG. 5 illustrates a block diagram of components of a network node 500 which are configured to operate in accordance with some embodiments of the present disclosure.

Referring to FIG. 5, the network node 500 includes one or more network interfaces 530 (referred to as “network interface” for brevity), one or more processors 510 (referred to as “processor” for brevity), and one or more memories 520 (referred to as “memory” for brevity) storing instructions 522. The network interface 530 may be configured to communicate through a wired interface, e.g., Ethernet, and/or wireless interface, e.g., wireless transceiver, according to one or more proprietary protocols and/or industry standardized protocols. The processor 510 may include one or more data processing circuits, such as a general purpose and/or special purpose processor (e.g., microprocessor and/or digital signal processor), that may be collocated or distributed across one or more networks and/or one or more application specific integrated circuits that may be collocated or distributed across one or more networks. The processor 510 is configured to execute the instructions 522 in the memory 520, described below as a non-transitory computer readable medium, to perform some or all of the operations and methods that are described above for one or more of the embodiments of the UDF 110, the SMF 120, the CHF 130, the CGF/mediation 140, the billing system 150, and/or other network components of a communications system disclosed herein.

In the above-description of various embodiments of the present disclosure, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

References used herein are listed below:
[1] 3GPP TS 32.291 V17.4.0: “5G system, charging service; Stage 3”
[2] 3GPP TS 32.298 V17.4.0: “Charging Data Record (CDR) parameter description”
[3] IETF RFC 6733: “Diameter Base Protocol”
[4] IETF RFC 8506: “Diameter Credit-Control Application”
[5] 3GPP TR 28.826 V1.0.0: “Study on Nchf charging services phase 2 improvements and optimizations”.

### Listing of Embodiments

1. A method by a first function (130) of a network node (500) of a communications system for encoding a charging data record, CDR, the method comprising:
receiving (204,300) charging information containing attributes and values that are coded according to a service based interface, SBI, syntax;
identifying (204,302) a structure of a first part of the CDR that is undefined by a first CDR syntax for storage of a combination of an attribute and value of the charging information in the CDR;
hashing (204,304) the structure of the first part of the CDR to generate a hash value; and
storing (204,306) the hash value and the combination of the attribute and value in a second part of the CDR which is defined by the first CDR syntax for use in storage of undefined attributes and values.
2. The method of Embodiment 1, further comprising:
providing (208) the CDR, containing the hash value and the combination of the attribute and value, to a second function (140,150) of either the network node or another network node.
3. The method of any of Embodiments 1 to 2, wherein:
the structure of the first part of the CDR is a nested data structure containing hierarchical levels of nested attributes; and
the hashing (204,306) of the structure of the first part of the CDR to generate the hash value, comprises hashing at least one of the hierarchical levels of the nested attributes.
4. The method of Embodiment 3, wherein the hashing of the at least one of the hierarchical levels of the nested attributes, comprises:
selecting a highest one of the hierarchical levels of the nested attributes that is undefined by the first CDR syntax for storage of the combination of the attribute and value in the CDR; and
hashing the highest one of the hierarchical levels of the nested attributes and any lower ones of the hierarchical levels of the nested attributes to generate the hash value.
5. The method of any of Embodiments 1 to 4, wherein:
the first function (130) of the network node comprises a charging function; and
the first function (140, 150) receives the charging information from a charging trigger function (200).
6. The method of Embodiment 5, wherein:
the first function (130) receives the charging information from a session management function, a short message service function, or a network exposure function.
7. A computer program product comprising:
a non-transitory computer readable medium storing instructions configured to be executed by at least one processor of a network node (500) of a communications network to cause the at least one processor to perform the method of any of Embodiments 1 to 6.
8. A method by a second function (140,150) of a network node (500) of a communications system, the method comprising:
receiving (210,400) a charging data record, CDR, that contains a hash value and a combination of an attribute and value stored at a second part of the CDR which is defined by a first CDR syntax for use in storage of undefined attributes and values;
matching (210,402) the hash value to a reference hash value identifying a first part of the CDR that is defined by a second CDR syntax for use in storage of the combination of the attribute and value in the CDR; and
storing (210,404) the combination of the attribute and value in the first part of the CDR.
9. The method of Embodiment 8, further comprising:
hashing a structure of the first part of the CDR, that is defined by the second CDR syntax, to generate the reference hash value.
10. The method of Embodiment 9, wherein:
the structure of the first part of the CDR is a nested data structure containing hierarchical levels of nested attributes; and
the hashing of the structure of the first part of the CDR to generate the reference hash value, comprises hashing at least one of the hierarchical levels of the nested attributes.
11. The method of Embodiment 10, wherein the hashing of the at least one of the hierarchical levels of the nested attributes, comprises:
selecting a highest one of the hierarchical levels of the nested attributes that is undefined by the first CDR syntax for storage of the combination of the attribute and value in the CDR and is defined by the second CDR syntax for storage of the combination of the attribute and value in the first part of the CDR; and
hashing the highest one of the hierarchical levels of the nested attributes and any lower ones of the hierarchical levels of the nested attributes to generate the hash value.
12. The method of Embodiment 8, further comprising:
accessing a table that associates reference hash values to parts of the CDR which are defined by the second CDR syntax for use in storage of combinations of attributes and values; and
using the hash value as a pointer in the table to lookup the first part of the CDR.
13. A computer program product comprising:
a non-transitory computer readable medium storing instructions configured to be executed by at least one processor of a network node (500) of a communications network to cause the at least one processor to perform the method of any of Embodiments 8 to 12.
14. A first function (130) by a network node (500) of a communications system for encoding a charging data record, CDR, the network node (500) comprising:
at least one processor (510); and
at least one memory (520) coupled to the at least one processor (510) and storing computer readable program code that when executed by the at least one processor (510) causes the at least one processor (510) to perform operations configured to:
   receive charging information containing attributes and values that are coded according to a service based interface, SBI, syntax;
   identify a combination of an attribute and value of the charging information that is undefined by a first CDR syntax for storage in the CDR;
   identify a structure of a first part of the CDR that is defined by a second CDR syntax for storage of the combination of the attribute and value;
   hash the structure of the first part of the CDR that is defined by a second CDR syntax to generate a hash value; and
   store the hash value and the combination of the attribute and value in a second part of the CDR which is defined by the first CDR syntax for use in storage of undefined attributes and values.
15. The first function (130) in the network node (500) of Embodiment 14, wherein the operations are further configured to:
provide the CDR, containing the hash value and the combination of the attribute and value, to a second function (140,150) of either the network node or another network node.
16. The first function (130) in the network node (500) of any of Embodiments 14 to 15, wherein:
the structure of the first part of the CDR is a nested data structure containing hierarchical levels of nested attributes; and
the operation to hash the structure of the first part of the CDR to generate the hash value, comprises to hash at least one of the hierarchical levels of the nested attributes.
17. The first function (130) in the network node (500) of Embodiment 16, wherein the operation to hash at least one of the hierarchical levels of the nested attributes, comprises to:
select a highest one of the hierarchical levels of the nested attributes that is undefined by the first CDR syntax for storage of the combination of the attribute and value in the CDR and is defined by the second CDR syntax for storage of the combination of the attribute and value in the first part of the CDR; and
hash the highest one of the hierarchical levels of the nested attributes and any lower ones of the hierarchical levels of the nested attributes to generate the hash value.
18. The first function (130) in the network node (500) of any of Embodiments 14 to 17, wherein:
the first function (130) of the network node comprises a charging function; and
the first function (140, 150) receives the charging information from a charging trigger function (200).
19. The first function (130) in the network node (500) of Embodiment 18, wherein:
the first function (130) receives the charging information from a session management function, a short message service function, or a network exposure function.
20. A second function (140,150) by a network node (500) of a communications system, the network node (500) comprising:
at least one processor (510); and
at least one memory (520) coupled to the at least one processor (510) and storing computer readable program code that when executed by the at least one processor (510) causes the at least one processor (510) to perform operations configured to:
   receive a charging data record, CDR, that contains a hash value and a combination of an attribute and value stored at a second part of the CDR which is defined by a first CDR syntax for use in storage of undefined attributes and values;
   match the hash value to a reference hash value identifying a first part of the CDR that is defined by a second CDR syntax for use in storage of the combination of the attribute and value; and
   store the combination of the attribute and value in the first part of the CDR.
21. The second function (140,150) of the network node (500) of Embodiment 20, wherein the operations are further configured to:
hash a structure of the first part of the CDR, that is defined by the second CDR syntax, to generate the reference hash value.
22. The second function (140,150) of the network node (500) of Embodiment 21, wherein:
the structure of the first part of the CDR is a nested data structure containing hierarchical levels of nested attributes; and
the operation to hash the structure of the first part of the CDR to generate the reference hash value, comprises to hash at least one of the hierarchical levels of the nested attributes.
23. The second function (140,150) of the network node (500) of Embodiment 22, wherein the operation to hash the at least one of the hierarchical levels of the nested attributes, comprises to:
select a highest one of the hierarchical levels of the nested attributes that is undefined by the first CDR syntax for storage of the combination of the attribute and value in the CDR and is defined by the second CDR syntax for storage of the combination of the attribute and value in the first part of the CDR; and
hash the highest one of the hierarchical levels of the nested attributes and any lower ones of the hierarchical levels of the nested attributes to generate the hash value.
24. The second function (140,150) of the network node (500) of Embodiment 20, wherein the operations are further configured to:
access a table that associates reference hash values to parts of the CDR which are defined by the second CDR syntax for use in storage of combinations of attributes and values; and
use the hash value as a pointer in the table to lookup the first part of the CDR.

1. A method by a first function of a network node of a communications system for encoding a charging data record, CDR, the method comprising:
receiving charging information containing attributes and values that are coded according to a service based interface, SBI, syntax;
identifying a structure of a first part of the CDR that is undefined by a first CDR syntax for storage of a combination of an attribute and value of the charging information in the CDR;
hashing the structure of the first part of the CDR to generate a hash value; and
storing the hash value and the combination of the attribute and value in a second part of the CDR which is defined by the first CDR syntax for use in storage of undefined attributes and values.

2. The method of claim 1, further comprising:
providing the CDR, containing the hash value and the combination of the attribute and value, to a second function of either the network node or another network node.

3. The method of claim 1, wherein:
the structure of the first part of the CDR is a nested data structure containing hierarchical levels of nested attributes; and
the hashing of the structure of the first part of the CDR to generate the hash value, comprises hashing at least one of the hierarchical levels of the nested attributes.

4. The method of claim 3, wherein the hashing of the at least one of the hierarchical levels of the nested attributes, comprises:
selecting a highest one of the hierarchical levels of the nested attributes that is undefined by the first CDR syntax for storage of the combination of the attribute and value in the CDR; and
hashing the highest one of the hierarchical levels of the nested attributes and any lower ones of the hierarchical levels of the nested attributes to generate the hash value.

5. The method of claim 1, wherein:
the first function of the network node comprises a charging function; and
the first function receives the charging information from a charging trigger function.

6. The method of claim 5, wherein:
the first function receives the charging information from a session management function, a short message service function, or a network exposure function.

7. (canceled)

8. A method by a second function of a network node of a communications system, the method comprising:
receiving a charging data record, CDR, that contains a hash value and a combination of an attribute and value stored at a second part of the CDR which is defined by a first CDR syntax for use in storage of undefined attributes and values;
matching the hash value to a reference hash value identifying a first part of the CDR that is defined by a second CDR syntax for use in storage of the combination of the attribute and value in the CDR; and
storing the combination of the attribute and value in the first part of the CDR.

9. The method of claim 8, further comprising:
hashing a structure of the first part of the CDR, that is defined by the second CDR syntax, to generate the reference hash value.

10. The method of claim 9, wherein:
the structure of the first part of the CDR is a nested data structure containing hierarchical levels of nested attributes; and
the hashing of the structure of the first part of the CDR to generate the reference hash value, comprises hashing at least one of the hierarchical levels of the nested attributes.

11. (canceled)

12. The method of claim 8, further comprising:
accessing a table that associates reference hash values to parts of the CDR which are defined by the second CDR syntax for use in storage of combinations of attributes and values; and
using the hash value as a pointer in the table to lookup the first part of the CDR.

13. (canceled)

14. A first function by a network node of a communications system for encoding a charging data record, CDR, the network node comprising:
at least one processor; and
at least one memory coupled to the at least one processor and storing computer readable program code that when executed by the at least one processor causes the at least one processor to perform operations configured to:
receive charging information containing attributes and values that are coded according to a service based interface, SBI, syntax;
identify a combination of an attribute and value of the charging information that is undefined by a first CDR syntax for storage in the CDR;
identify a structure of a first part of the CDR that is defined by a second CDR syntax for storage of the combination of the attribute and value;
hash the structure of the first part of the CDR that is defined by a second CDR syntax to generate a hash value; and
store the hash value and the combination of the attribute and value in a second part of the CDR which is defined by the first CDR syntax for use in storage of undefined attributes and values.

15. The first function in the network node of claim 14, wherein the operations are further configured to:
provide the CDR, containing the hash value and the combination of the attribute and value, to a second function of either the network node or another network node.

16. The first function in the network node of claim 14, wherein:
the structure of the first part of the CDR is a nested data structure containing hierarchical levels of nested attributes; and
the operation to hash the structure of the first part of the CDR to generate the hash value, comprises to hash at least one of the hierarchical levels of the nested attributes.

17. (canceled)

18. The first function in the network node of claim 14, wherein:
the first function of the network node comprises a charging function; and
the first function receives the charging information from a charging trigger function.

19. The first function in the network node of claim 18, wherein:
the first function receives the charging information from a session management function, a short message service function, or a network exposure function.

20. A second function by a network node of a communications system, the network node comprising:
at least one processor; and
at least one memory coupled to the at least one processor and storing computer readable program code that when executed by the at least one processor causes the at least one processor to perform operations configured to:
receive a charging data record, CDR, that contains a hash value and a combination of an attribute and value stored at a second part of the CDR which is defined by a first CDR syntax for use in storage of undefined attributes and values;
match the hash value to a reference hash value identifying a first part of the CDR that is defined by a second CDR syntax for use in storage of the combination of the attribute and value; and
store the combination of the attribute and value in the first part of the CDR.

21. The second function of the network node of claim 20, wherein the operations are further configured to:
hash a structure of the first part of the CDR, that is defined by the second CDR syntax, to generate the reference hash value.

22. The second function of the network node of claim 21, wherein:
the structure of the first part of the CDR is a nested data structure containing hierarchical levels of nested attributes; and
the operation to hash the structure of the first part of the CDR to generate the reference hash value, comprises to hash at least one of the hierarchical levels of the nested attributes.

23. The second function of the network node of claim 22, wherein the operation to hash the at least one of the hierarchical levels of the nested attributes, comprises to:
select a highest one of the hierarchical levels of the nested attributes that is undefined by the first CDR syntax for storage of the combination of the attribute and value in the CDR and is defined by the second CDR syntax for storage of the combination of the attribute and value in the first part of the CDR; and
hash the highest one of the hierarchical levels of the nested attributes and any lower ones of the hierarchical levels of the nested attributes to generate the hash value.

24. The second function of the network node of claim 20, wherein the operations are further configured to:
access a table that associates reference hash values to parts of the CDR which are defined by the second CDR syntax for use in storage of combinations of attributes and values; and
use the hash value as a pointer in the table to lookup the first part of the CDR.
